(19) United States
(12) Patent Application Publication
(10) Pub. No.: US 2005/0114179 A1
(43) Pub. Date: May 26, 2005

(54) Method and apparatus for constructing and viewing a multi-media patient summary

(76) Inventors: Charles Cameron Brackett, Overland Park, KS (US); Steven Lawrence Fors, Chicago, IL (US); Mark M. Morita, Arlington Heights, IL (US)

Correspondence Address: Patrick S. Yoder;FLETCHER YODER, P.O. Box 692289, Houston, TX, 77269-2289, US

(21) Appl. No.: 10/723,676

(22) Filed: Nov. 26, 2003

(51) Int. Cl. G06F 17/60

(52) U.S. Cl. 705/2

(57) ABSTRACT

The present technique provides a novel method and apparatus for generating a multi-media patient summary which integrates patient information including a wide range of information having disparate formats and originating from isolated systems. The multi-media may be delivered to care providers and patients for use in medical diagnosis and care. The contents of the multi-media patient summary may be tailored to meet the needs of the specific care provider, and may include, for example, clinical data, patient demographics, and reference materials. The summary may be a digital file that encapsulates patient information having formats, such as text, images, sound files, video, waveforms, hypertext links, and so forth. The file may be encrypted and require a proprietary or non-proprietary reader to view. Additionally, the flow of information may be bi-directional between the multi-media patient summary and users of the summary.

### BACKGROUND OF THE INVENTION

The present invention relates generally to field of medical information processing and analysis. More particularly, the invention relates to techniques for summarizing patient information available from a wide range of sources for informing decisions related to diagnosis and treatment.

In the medical field many different types and sources of patient information and data are available for learning about and treating patient conditions. Over the past decades, and especially in recent years, the volume and detail of patient information (i.e., diagnostic resources) available to the health practitioner and the patient have greatly expanded, offering the potential to significantly enhance and improve patient care. In particular, patient information currently available to physician and other caretakers may include results of analyses and tests, such as those prescribed to explore potential physical/medical conditions and to pinpoint potential causes of medical problems.

Traditional prescribable sources of patient information include, for example, simple blood tests, urine tests, manually recorded results of physical examinations, and the like. Over recent decades, more sophisticated techniques have been developed that include various types of electrical data acquisition which detect and record the operation of systems of the body and, to some extent, the response of such systems to situations and stimuli. Even more sophisticated systems have been developed that provide images of the body, including internal features, which could only be viewed and analyzed through surgical intervention before their development, and which permit viewing and analysis of other features and functions which could not have been seen in any other manner. In general, the results of these prescribable analyses may be electronically documented, for example, in the form of text, graphs, waveforms, discrete values, audio, images, video, and the like.

In addition to the results of tests and analyses, patient information may also include a wide assortment of data, such as, patient identification data, financial and insurance information, patient demographics, and so forth. Patient demographics, for example, may encompass gender, age, race, marital status, medical history, psychiatric history, drug use, food intake, and the like. Such information may be obtained, for example, from patient questionnaires, which if hardcopy may later be digitized.

Furthermore, patient information may originate from generic reference resources, which aid in evaluation of patient-specific issues or conditions. In particular, reference materials are now available from many sources that provide physicians with detailed information on possible disease states, and information on how to recognize and treat such states. Similar reference materials are available that identify such considerations as drug interactions, predispositions for disease and medical events, and so forth.

All of these techniques and resources have added to the vast array of patient information available to physicians, and offer to greatly improve the quality of medical care. As might be expected, however, challenges and opportunities exist for more efficient delivery of patient information to physicians and other caregivers. At present, improved integration and accessibility of patient information are needed. Significant impediments exist due to the sheer volume and diversity of information.

Patient information and data, particularly in recent years, are increasingly handled in digitized or electronic form. Such information may be generated initially in an electronic format, or if generated as hardcopy, it may be digitized, for example, by scanning or entering information into electronic form. The electronic manipulation, storing, and accessing of data, in the medical field, offers both opportunities and hurdles in the efficient delivery of patient information to the caretaker and patient.

The dramatic increase and improvement in the sources of medical-related information and the prescription/analysis of tests and data contribute to the availability of improved diagnostic resources, but also create architectural and other barriers to the accessibility and integration of patient information. For example, among the obstacles to effective retrieval and utilization of patient information are the isolated, cumbersome systems that provide the information. As will be appreciated by those skilled in the art, considerable training and time are required for a clinician to access patient information stored in these incongruent systems. Such systems may include, for example, the picture and archival communication system (PACS), hospital information system (HIS), radiological information system (RIS), cardiovascular information system (CVIS), and the like.

It may be difficult, for example, for a caretaker, such as a clinician or referring physician, to access relevant patient information and reports because, in many scenarios, physicians that need patient information do not have the necessary background on how to utilize these isolated systems that manage and process patient information. Indeed, the user interfaces of patient information systems are generally targeted towards specialists. Much of the features and functionality of these systems have little meaning to the typical clinician and can create a frustrating experience. Furthermore, information on a particular patient is not always available in a single area, causing clinicians to spend time searching, back and forth, among the various systems.

The volume and detail of information of a given patient are often overwhelming for a typical clinician, such as a referring physician, who would be typically better served by summarized or distilled information integrated within a single source, with additional capability for the clinician to extract more detailed information if necessary. A problem is that patient information systems are commonly difficult to integrate. Indeed, the diverse system codes and hardware are frequently system-dedicated and/or unique, and may not possess effective capability to communicate with each other. System codes may include, for example, hypertext markup language (HTML), extended markup language (XML), Digital Imaging and Communications in Medicine (DICOM), Health Level Seven® (HL7), and so forth. Challenges to integrating patient information also involve the disparate forms of patient information, such as text, images, waveforms, audio, video, and so forth.

Patient information in the form of text, a traditional form, may exist in a variety of formats and may exist independently or combined with images or waveforms. Medical images may be stored, for example, as jpeg or gif files, and may only be accessible through dedicated systems, such as a PACS workstation or an RIS workstation. A wide variety of waveforms may be generated by various modalities for a given patient, and may be stored in a graphics format. Audio may be stored, for example, as “mpeg” or “avi” files, and is increasingly being utilized to document or summarize patient demographics and analytical data. Other audio, such as recorded annotations or commentary of images and waveforms, would be more beneficial if the assortment of data forms were better integrated. In general, patient information in the medical field is affected by its volume, detail, and lack of system coherence.

The integration of large quantities of diverse patient data in the medical field poses specific problems and challenges unaddressed by the prior art. Indeed, coordinating access and interfacing to large quantities of disparate, separate data sets has been unaddressed in the past simply because high levels of patient data were unavailable to a degree that would require unique interfacing approaches.

Specific challenges which arise when large amounts of patient information are made available, affect both the interface between users and the systems cataloging and storing the data, and access issues. While a large number of users may desire and have use for particular data points, not all users will have similar interests in either the data, processing of the data, or relationships between data points. Users, in various medical-related fields, might include such diverse individuals and entities as medical institutions, radiology departments, physicians, governmental bodies, employers, insurance companies, not to mention the patient himself. However, to be meaningful, the interface should be tailored to the specific user, as should the level of access permitted.

There is a need, at present, for improved interfacing approaches which allow for users to straightforwardly access relevant patient information. Similarly, there is a need for user-friendly systems that distill and summarize disparate and voluminous patient information and deliver relevant information to the clinician or patient in an integrated and usable format for medical diagnosis and care. In addition, these clinicians or patients should have the capability to access more detailed information if necessary. Conversely, some users may not have rights to access various types of information. In such situations, free access to all data in a repository would be inappropriate, and judicious allocation of access to these resources is in order.

### BRIEF DESCRIPTION OF THE INVENTION

The present technique provides a novel approach to facilitate the delivery of relevant patient information to care providers by addressing the storing, interfacing, and accessing of patient data. In particular, the present technique provides a method and apparatus for encapsulation and integration of disparate patient data into a useable form. A multi-media patient summary unifies different formats of patient information from different systems for delivery to care providers for use in medical diagnosis and care. Such care providers may include, for example, referring physicians, radiologists, surgeons, nurses, clinicians, various specialists, patients, clerical staff, insurance companies, teachers and students, and so forth. Of course, the contents of the multi-media patient summary may be tailored to the needs of the specific care provider.

In accordance with one aspect of the invention, a multi-media patient summary may include a digital file encapsulating patient information of one or more formats and generated by accessing patient information at a compilation workstation from one or more systems, entering the patient information into the digital file, storing the digital file onto a machine readable medium, and loading the digital file at one or more remote client workstations. The one or more formats of the patient information may be a text, an image, a waveform, audio, a hypertext link, and the like. The patient information may be accessed from at least one of an image handling system, an information system, a diagnostic modality interface, and so forth.

In accordance with another aspect of the invention, a method for providing a multi-media patient summary, a method that may include accessing patient information of one or more formats from one or more systems to a compilation workstation, assembling the patient information into a digital file, storing the digital file onto a machine readable medium, accessing the digital file at one or more client workstations, and electronically transmitting the digital file to a client. A format of the digital file may be an encapsulated file having patient information in a format of at least one of text, images, sound files, waveforms, and hypertext links. Systems that supply patient information may be a picture archival communication system, a radiology department information system, a hospital information system, a cardiovascular information system, magnetic resonance imaging system, computed tomography imaging system and so forth. The client workstation may be, for example, a general purpose computer or a personal digital assistant electronic handheld device. The digital file may be configured to be accessed by a physician or patient at the one or more client workstations.

In accordance with yet another aspect of the invention, a method for generating a multi-media patient summary may include configuring an electronic template at a compilation workstation to receive patient information of one or more formats from one or more systems, receiving and encapsulating the patient information in the electronic template and compiling a multi-media patient summary, storing the multi-media patient summary on a machine readable medium, and displaying the multi-media patient summary at one or more remote client workstations. The method may also include notifying a client of the status of the multi-media patient summary. The method may further include accessing and replaying one or more patient information sound files compiled in the multi-media patient summary and/or viewing one or more patient information images or waveforms compiled in the multi-media patient summary. The method may include selecting one or more user-selectable regions of the multi-media patient summary to display additional patient information. The patient information may be received from a picture archival communication system, a. hospital information system, a radiology department information system, an MRI system, a CT system, a electrocardiography system, and the like.

Facets of the invention may provide a system for creating a multi-media patient summary, including at least one compilation workstation configured to receive patient information of one or more formats from one or more sources, the at least one compilation workstation configured to assemble and encapsulate the patient information into a digital file, the at least one compilation workstation configured to store the digital file on at least one machine readable medium, and at least one client workstation capable of accessing the digital file. The format of the patient information may be, for example, text, an image, a waveform, audio, and a hypertext link. The patient information may be supplied from at least one of an image handling system, an information system, and a diagnostic modality interface.

Other facets of the invention may give a system for providing a multi-media patient summary, the system including means for accessing patient information of one or more formats from one or more systems, means for assembling the patient information into an electronic file capable of encapsulating patient information having different formats, and means for storing and accessing the electronic file.

Aspects of the invention may provide a computer program, provided on one or more tangible media, for generating a multi-media patient summary, including a routine for receiving patient information of one or more formats from one or more systems at to one or more compilation workstations, a routine for assembling and encapsulating the patient information into a digital file, a routine for storing the digital file onto one or more machine readable media, and a routine for loading the digital file at one or more client workstations. The patient information may be provided from an image handling system, an information system, a diagnostic modality interface, and the like. The format of the patient information may be text, an image, a waveform, audio, a hypertext link, and so forth. The one or more client workstations may be a general purpose computer, a personal digital assistant electronic handheld device, and the like.

### BRIEF DESCRIPTION OF THE DRAWINGS

FIG. 1 is a general overview of exemplary patient information sources and a system for generating a multi-media patient information summary;

FIG. 2 is a general overview of a system for generating a multi-media patient summary;

FIG. 3 is a block diagram of an exemplary technique for creating and delivering a multi-media patient summary;

FIG. 4 is a perspective view of one view of a multi-media patient summary.

### DETAILED DESCRIPTION OF SPECIFIC EMBODIMENTS

The present technique provides for a multi-media patient summary having an integrated, summarized patient record, which may include a wide range of information having disparate formats and originating from isolated systems. The summary may include data acquired by automated techniques and by human care providers, from patients and institutions which provide care to the patient, as well as derived data, such as that resulting from analysis of raw patient data, image data, and the like. Additionally, the multi-media patient summary may include information incorporated from reference data repositories. The specific contents and templates of the summary may vary, for example, depending on the function of the user or client. The multi-media patient summary may be stored for access and/or delivered to caregivers and patients.

In general, the patient information in the multi-media patient summary may include any and all types of available medical data which can be processed, for example, via a workstation connected to a medical facility data network system, and ultimately made available to the clinicians for providing the desired medical care. In the simplest implementation, resources may include a single source of medical data, such as an imaging system, or more conventional data extraction techniques (e.g. forms completed by a patient or care provider). However, the resources may include many more and varied types of data. In general, patient data may be digitized and stored to make the data available for extraction and analysis. Thus, even where more conventional data gathering resources are employed, the data is commonly placed in a form which permits it to be identified and extracted via, for example, a medical facility data network.

On the whole, these resources for patient information may be thought of as primarily clinical resources of various types of modalities and data analyses, such as imaging systems, electrical parameter detection devices, data input by clinicians, and so forth. Other data resources, however, may be quasi-clinical consisting of, for example, reference sources which may provide information regarding medical events, medical conditions, and disease states, that in general, are not directly collected from the patient, but the selection of which may depend on information gathered from the patient. These reference resources are more general in nature and may be obtained through data reference libraries, subscriptions, and so forth. In sum, both clinical and quasi-clinical patient information, as well as, other types of patient information may be useful to include in the multi-media patient summary of the present technique.

A “medical facility data network” may include one or more local or remote repositories of medical-related data in a broad sense, as well as interfaces and translators between the repositories, and processing capabilities including analysis, reporting, display and other functions. The repositories and processing resources may be expandable and may be physically resident at any number of locations, typically linked by dedicated or open network links. The flow of information may include a wide range of types and vehicles for information exchange. The resources of patient information for the multi-media patient summary may include any number of data gathering devices, mechanisms, and procedures which acquire data directly or indirectly from the patient.

Of course, the collection of patient information typically starts with the patient who may interface with clinicians through conventional clinical visits, as well as remotely by telephone, electronic mail, forms, and so forth. Patients may also interact via a range of patient data acquisition interfaces, such as conventional patient history forms, interfaces for imaging systems and other modalities, and so forth. Clinicians may also interact with data acquisition interfaces, such as workstations, computers, portable or remote input and reporting devices, and the like. The network links may typically include computer interconnections, network connections, local area networks, virtual private networks, and so forth.

Prior to a patient visit, a record for the patient contact or medical event (e.g. the reason for the visit) may be captured to begin a new or continuing multi-media patient summary. Based upon analysis of pre-visit patient information, such as patient history, symptoms, and the like, various recommendations and actions may include ordering and scheduling of exams and data acquisition to provide the most relevant information likely to be needed for efficient diagnosis and feedback. A clinician, specialist, or operator, may upload these recommendations and other data to the multi-media patient summary by using, for example, an existing institutional application, such as a hospital information system (HIS). On the other hand, the clinician, specialist, or operator may use a variety of other means, such as a simple computer interface, to upload the recommendations and other data.

Patient information may be collected during one or more on-site visits. Patient conversation and inputs may be recorded, such as voice and video data, which can be documented in the multi-media patient summary. Text, such as reports, recommendations, educational material, and so forth, as well as, acquired images or waveforms, may be input into the multi-media patient summary. Post-visit data collection and analysis may include follow-up questions and answers, symptom updates, and the like, which also may be pushed to the patient summary. In sum, the material assembled in the multi-medial patient summary may include, for example, text, images, animations, graphics, and other reference material, raw or processed, structured video and/or audio recordings of questions and answers, general data on background, diagnoses, medical regimens, risks, referrals, and so forth. Other information such as financial arrangements, including insurance data, claims data, and the like, may also be included.

In one embodiment, the multi-media patient summary may be constructed in an encapsulated file format and whose contents are pushed from information systems, such as the picture archival communication system (PACS), hospital information system (HIS), and radiology department information system (RIS). The summary may be targeted, for example, toward a referring physician, and thus, the interface may be constructed to match the typical referring physician's background and training. The file may be encrypted and/or require a user-friendly proprietary reader to retrieve. Access may be controlled with typical security measures.

As mentioned in this example, the contents and interface are geared toward a referring physician, and thus, only patient information relevant to a referring physician and their patients are included. Such information may include, for example, patient reports (i.e., text), radiologist dictation (i.e., compressed sound “mp3” files), key images and waveforms, and so forth. Hypertext links may be included for the referring physician to access more detailed information, such as high-resolution images, raw analytical results, reference materials, and the like.

For supply of information to the summary, specialists and others may input raw or distilled information via network data links to the multi-media patient summary file while or after conducting exams/analyses of a patient. As before, the specialist or technician may utilize existing systems for the typical processing, storing, and handling of patient data, but with the present technique, the specialist may also push raw or summarized information into the multi-media patient summary. In this embodiment, the summary file encapsulates the various formats of patient information received and is intended to compliment and not replace existing standards, such as DICOM, HL7®, and the like.

For access, the patient summary file may be distributed, for example, to designated referring physician(s) through electronic mail (email) or other electronic means. Similarly, the physician may be notified, for example, via wireless cell/page/voice of the status and location of a multi-media patient summary. The summary may be sent, for example, at times specified by the referring physician, such as during an exam. Different information may populate this exemplary patient summary file depending on the stage of an exam and the available information. For example, image data may differ depending on whether an image has been acquired, dictated, transcribed, and/or approved/appended.

Furthermore, the referring physician may receive information they need just in time (JIT) on the platform of their choice without having to navigate the diagnostic workstations, such as PACS or RIS workstations. A file reader, such as a free downloadable reader, may be required to view and interact with this exemplary multimedia patient summary. This reader may be used, for example, as a standalone reader or as a plug-in to be used with any internet browser. Again, it should be noted that in this example, the file format may not be intended to replace existing standards, such as DICOM, HL7®, and the like.

Finally, a user may be responsible for setting the security or access level for data generated or administrated by that user, or other participants may be responsible for such security and access control. The system for accessing the multi-media patient summary can be programmed to implement default access levels for different types of users or user functions. Moreover, different privacy levels may be set for individual patients, specialists, and so forth.

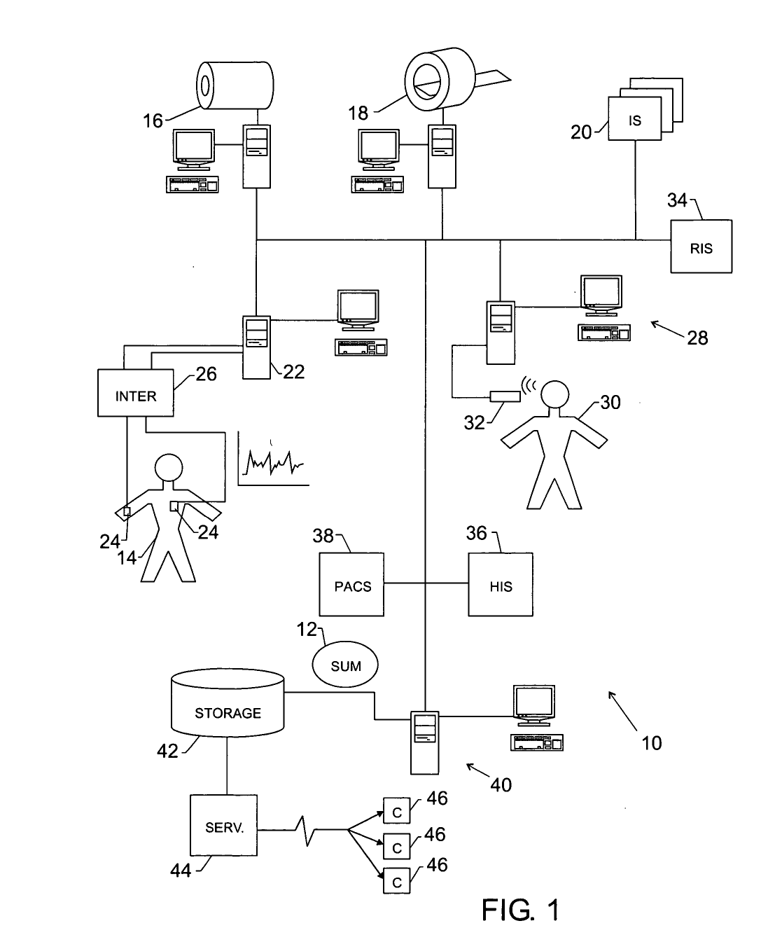

Turning now to the drawings, and referring first to FIG. 1, an overview of a multi-media patient summary generating system 10 is illustrated. The system 10 provides a multi-media patient summary 12 of a patient 14. Generation and receipt of patient data, and the compiling and delivery of the patient summary 12 are discussed below.

Sources of patient information may include one or more imaging systems, such as a magnetic resonance imaging (MRI) system 16 or a computed tomography (CT) imaging system 18. Other imaging acquisition systems may also supply data to the multi-media patient summary 12. Such acquisition systems may include, for example, x-ray imaging systems, positron emission tomography (PET) systems, mammography systems, sonography systems, infrared imaging systems, nuclear imaging systems, and so forth. Imaging resources are typically available for diagnosing medical events and conditions in both soft and hard tissue, for analyzing structures and function of specific anatomies, and in general, for screening internal body parts and tissue. The components of an imaging system generally include some type of imager which detects signals and converts the signals to useful data. In general, image data indicative of regions of interest in a patient 14 are created by the imager either in a conventional support, such as photographic film, or in a digital medium. In the case of analog media, such as photographic film, the hard copies produced may be subsequently digitized. Ultimately, image data may be forwarded to some type of operator interface in the medical facility data network for viewing, storing, and analysis.

In the specific example of an MRI, the imaging system 16 includes a scanner having a primary magnet for generating a magnetic field. A patient 14 is position against the scanner and the magnetic field influences gyromagnetic materials within the patient's 14 body. As the gyromagnetic material, typically water and metabolites, attempts to align with the magnetic field, other magnets or coils produce additional magnetic fields at differing orientations to effectively select a slice of tissue through the patient 14 for imaging. Data processing circuitry receives the detected MR signals and processes the signals to obtain data for reconstruction. The resulting processed image data is typically forwarded locally or via a network, to an operator interface for viewing, as well as to short or long-term storage.

For the example of CT, the basic components of a CT imaging system 18 include a radiation source and detector. During an examination sequence, as the source and detector are rotated, a series of view frames are generated at angularly-displaced locations around a patient 14 positioned within a gantry. A number of view frames (e.g. between 500 and 1000) may be collected for each rotation. For each view frame, data is collected from individual pixel locations of the detector to generate a large volume of discrete data. Data collected by the detector is digitized and forwarded to data acquisition and processing circuitries, which process the data and generate a data file accessible, for example on a medical facility data network.

Other modality acquisition systems 20 may also supply patient information to the multi-media patient summary 12. In this illustrative embodiment, patient information may be supplied to the multi-media patient summary 12 by a computer system 22 (patient data acquisition system) that collects sensor/monitor 24 data via an interface 26. This configuration may include, for example, a variety of data collection systems designed to detect physiological parameters of patients based upon sensed signals. Resulting output data, such as waveforms or video, may be stored in the computer system 22 and/or at other repositories or storage sites linked to the medical facility data network.

In particular, system 20 may represent imaging systems, clinical laboratory resources (such as blood or urine tests), histological data resources (such as tissue analysis or crytology), blood pressure analyses, and so forth. System 20 may also represent electrical data resources and modalities, such as electroencephalography (EEG), electrocardiography (ECG or EKG), electromyography (EMG), electrical impedance tomography (EIT), nerve conduction test, electronystagmography resources (ENG), combinations of such modalities, and so forth. For the example of electrical modalities or resources, components typically include sensors or transducers, such as sensor/monitors 24, which may be placed on or about a patient 14 to detect certain parameters of interest that may be indicative of medical events or conditions. Thus, the sensors 24 may detect electrical signals emanating from the body or portions of the body, pressure created by certain types of movement (e.g. pulse, respiration), or parameters such as movement, reactions to stimuli, and so forth. The sensors 24 may be placed on external regions of the body, but may also include placement within the body, such as through catheters, injected or ingested means, and so forth.

Patient information may also be supplied to the multi-media patient summary 12 in an audio format, for example, via an input/viewing station 28. For instance, audio data recorded by a clinician/radiologist 30 through an audio input device 32 (e.g., microphone) may be entered via station 28 into the multi-media patient summary 12. In this example, a radiological report is dictated by the clinician 30 to compliment or annotate the radiological images generated by the one or more of the imaging systems previously discussed. This exemplary combination of images and audio radiological reports accessible in a single file is a significant improvement over the traditional approach of archiving and transmitting radiological reports independently from the image files.

It is should be noted that suppliers of patient information, such as clinician/radiologist 30, may be the same or different clinicians, depending upon the modalities employed, and the needs of the patient. Ultimately, the general reference to clinicians in the present context is intended to include all trained personnel that may, from time to time, and individually or as a team, provide inputs and care required by the medical situation.

Within a hospital or institution, patient data may include a range of information types. For example, sources of information may be available within a radiology department information system (RIS) 34, such as in scanners, control systems, or departmental management systems or servers. Similarly, such information may be stored in an institution within a hospital information system (HIS) 36 in a similar manner. Many such institutions further include data, particularly image data, archiving systems, commonly referred to as PACS 38 in the form of compressed and uncompressed image data, data derived from such image data, data descriptive of system settings used to acquire images (such as in DICOM or other headers appended to image files), and so forth. In addition to data stored within institutions, data may be available from patient history databases. Such databases may be stored in a central repository within an institution, but may also be available from remote sources to provide patient-specific historical data.

Hospital systems, such as the RIS 34, HIS 36, and PACS 38, may generate patient information for input into the multi-media patient summary 12 in the form of text, images, waveforms, video, and audio, as discussed above. The RIS 34 is generally designed to support both administrative and clinical operations of a radiology department by managing, for example, radiology patient demographics and scheduling. The RIS 34 configuration may be very similar to the HIS 36 discussed below, except the RIS 34 is typically on a smaller scale. In most cases, an independent RIS 34 is autonomous with limited access to the HIS 36. However, some HIS 36 systems offer embedded RIS 34 subsystems with a higher degree of integration.

The HIS 36 is generally a computerized management system for handling tasks in a health care environment, such as support of clinical and medical patient care activities in the hospital, administration of the hospital's daily business transactions, and evaluation and forecasting of hospital performance and costs. The HIS 36 may provide for automation of events such as patient registration, admissions, discharged, transfers, and accounting. It may also provide access to patient clinical results (e.g., laboratory, pathology, microbiology, pharmacy, radiology).

It should be noted that radiology, pathology, pharmacy, clinical laboratories, and other clinical departments in a health care center typically have their own specific operational requirements, which differ from those of general hospital operation. For this reason, special information systems, such as the RIS 34, are typically needed. Often, these subsystems are under the umbrella of the HIS 36. Others may have their own separate information systems with interface mechanisms for transfer of data between these subsystems and the HIS 36. A software package, such as Summary True Oriented Results Reporting (STOR) may provide a path for the HIS 36 to distribute HL7®-formated data to other systems and the outside world. For example, the HIS 36 may broadcast in real time the patient demographics and encounter information with HL7® standards to other systems, such as to the RIS 34 and the PACS 38.

Many of these systems, however, are a mix-match of new and old components with software and hardware communication obstacles. Large-scale hospital information systems generally use mainframe computers which can be purchased through a manufacturer with customized software, or home-grown through the integration of many commercial products, progressively throughout the years. A home-grown system may contain many reliable legacy components, but with out-of-date technology. Therefore, in interfacing, for example, the HIS 36 to the PACS 38, it may be difficult to circumvent the legacy problem

A PACS 38 generally consists of image/data acquisition, controller and archival functions, and display subsystems, which may be integrated by digital networks. Images and related patient data may be sent from imaging modalities (devices) to the PACS 38. For example, in a peer-to-peer network, an imaging modality computer may “push” to a PACS 38 acquisition computer or the PACS 38 acquisition computer may “pull.” The PACS 38 acquisition computer, along with other information handling applications, such as the HIS 36, the RIS 34, may push imaging examinations along with pertinent patient information to a PACS 38 controller. The PACS 38 controller is the engine of the PACS 38, comprising, for example, high end computers or servers that provide for a database server and an archive server. The archive system may consist of short-term, long-term, and permanent storage. Finally, with the present technique, the PACS 38 may upload generated and stored data to the multi-media patient summary.

For the multi-media patient summary, a compilation workstation 40 may be used to assemble the patient information. The compilation workstation 40 may receive the patient data from the various systems previously discussed, such as the MRI system 16, CT system 18, HIS 36, PACS 38, and so forth. The assembled multi-media patient summary 12 after deposit in a storage 42 (memory) may be available for access via a server 44 by clients 46. Such clients 46 may be local or remote, and may include, for example, referring physicians, specialists, clinicians, other caretakers, patients, and so forth. A client workstation may include, for example, a personal computer or an electronic handheld device, such as personal digital assistant (PDA). It should be noted that the general references to clients 46 are intended to include all individuals, teams, automated systems, and so forth, that may utilize patient information.

In one embodiment, the client 46 of the multi-media patient summary 12 is the patient. The present technique offers advantages in the ability of patients to be informed and even assist in managing their own respective medical care. A multi-media patient summary 12 template can be configured in such a manner as to solicit additional information. Thus, the patient data, in implementation, may be exchanged in a bi-directional fashion such that the patient may provide information to the record and access information from the record. Such functions may be provided by “push” or “pull” exchange techniques, such as on a timed basis, or through notifications, electronic messages, wireless messages, and so forth. Similarly, the system offers the potential for improving the education of the patient as regards to general questions as well as specific clinical and non-clinical issues. Direct interaction with the patient may include, therefore, uploading of patient data, downloading of patient data, prescription reminders, office visit reminders, screening communications, and so forth. The mechanism can also be customized, and easily altered, for conformance with local, state and federal or other laws or regulations, particularity those relating to access to patient data. Moreover, the technique offers automatic or easily adapted compliance with hospital information system data access regulations, such that data can be flagged to insure privacy based upon the user or access method.

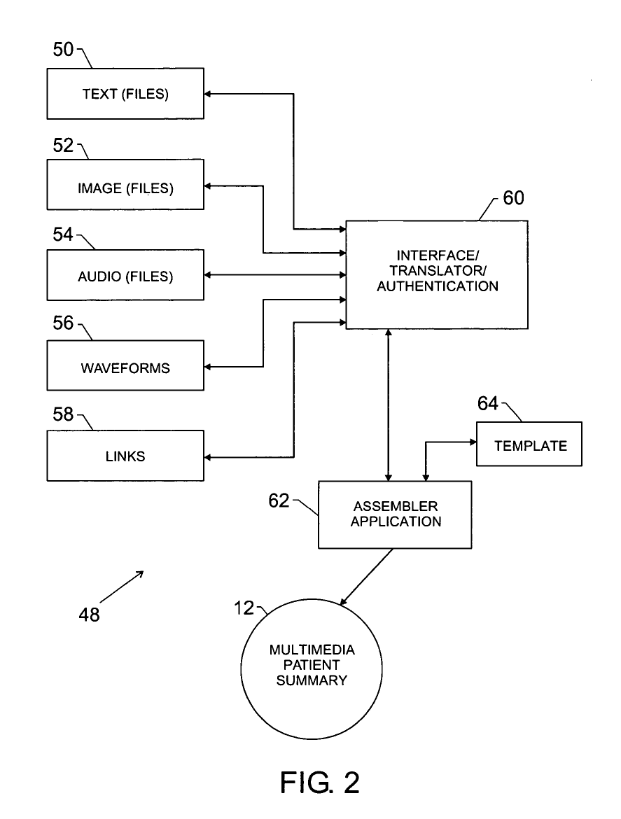

Referring to FIG. 2, a general overview of a multi-media patient summary generating system 48, is illustrated. Text 50, images 52, audio 54, waveforms 56, and hypertext links 58, represent sources and formats of patient information that may be assembled into patient summary 12 or further accessed via patient summary 12. This information may exist, for example, as digitized files supplied by one or more of the systems depicted in FIG. 1 and/or stored in one or more repositories linked to, for example, a medical facility data network. Such network links may include any suitable type of network connection or data communications, and any range of network or data transfer means, such as data busses, dial-up networks, high-speed broadband data exchanges, wireless networks, satellite communication systems, and so forth. When necessary, the resources that supply the patient data may translate the data from one form to another, including compression and decompression techniques, file formatting, and so forth.

An interface/translator/authentication module 60 may provide an interface to access the multi-media patient summary 12. Clinicians desiring access may include, for example, specialists who may supply patient data/information, operators who may assemble the information into the summary 12, and/or users, such as patients, referring physicians, and other specialists, who may read and utilize the summary 12. Clinicians, specialists, automated systems, and the like, may push patient data through interface/translator/authentication module 60 which receives the data to an assembler application module 62. Templates 64, such as those configured by a clinician for a referring physician or patient, may specify the contents and presentation of the multi-media patient summary 12.

Additionally, the interface/translator/authentication module 60 may translate and process data by compressing, decompressing, or modifying a data file. The information, such as text 50, images 52, audio 54, waveforms 56, and links 58 may be fed to the interface/translator/authentication module 60 where the data may be for example, converted or imported into a efficient format for use in the multimedia patient summary 12. A particularly powerful aspect of the present technique resides in the ability to integrate various resource data between types of resources, between various modalities of these types, and between acquisition processes. In particular, the module 60 may encapsulate the supplied data before assembly into a template 64 for the multimedia patient summary 12. Moreover, the module 60, for example, may reduce the resolution of images 52 as appropriate for a summary 12 and a particular client 46 (FIG. 1).

The flow between the data file sources and module 60 may be bi-directional such that, for example, the module 60 may translate and process data pushed from the data sources, as well as, send information to prompt or query the data sources. Additionally, the module 60 may pull information from the data sources, either manually via an operator or in an automated fashion. In addition to the translating and processing of patient data, the module 60 may control and authenticate access to the multi-media patient summary 12.

The interface/authentication/module 60 may permit various types of authentication to be performed, particularly for clinicians attempting to gain access to the multi-media patient summary 12. The authentication function may be achieved in a range of manners, including by password comparisons, voice recognition, biometrics, and so forth. Because a wide range of diverse data may be included in the multi-media patient summary, authentication and security issues can be the focus of specific software and devices to carefully guard access and avoid tampering or unauthorized access. Thus, in addition to the use of standard user authentication protocols, data encryption techniques may be employed, and associated infrastructure may be offered.

In a typical scenario, a user may enter an authentication module, such as on a workstation, to enable secure access to the multi-media patient summary. Where the function performed by the user is one of the criteria considered for interfacing and access, the user may be prompted to enter a current function, or the function may be recognized for the individual user profile. In this matter, the same user may have multiple functions in the system, such as in the case of thoracic radiologist at a hospital functioning as an interventionalist in one context and having additional functions as a mammographer at other periods, a manager at certain periods, and so forth. As a further example, a general practice nurse may function as a clinician at certain times, such as to input medical history information, and as an appointment scheduler at other times, and as a clerical person for input of billing, record data or insurance data at still other times.

The user function may also be a criterion that decides the contents of the multimedia patient summary as to relevance. For example, each individual or institution may customize or have access to one or more multi-media patient summary templates that specify information relevant to and based on the user function. Similarly, certain function-types of hardware or modality systems may have direct access to designated multi-media patient summary templates, such as for uploading or downloading information. Such hardware may include imaging systems, patient input stations, general purpose computers linked via websites, and so forth.

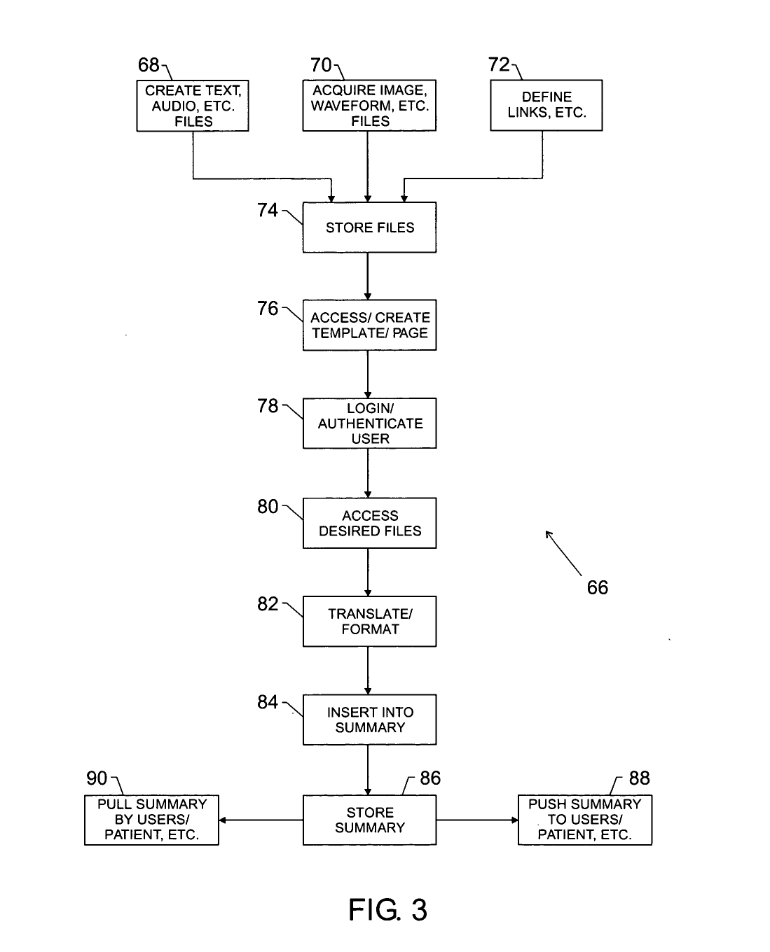

Referring to FIG. 3, a block diagram of a multi-media patient summary generating technique 66, is illustrated. As previously discussed, sources of information, such as sources that create text 50 and audio 54 files, acquire image 52 and waveform 56 files, and define hypertext links 58, may store these files and data, for example, locally or on a network (blocks 68, 70, 72, 74). An operator or clinician may access the system and create a template or page (block 76) that may, for example, specify the contents of the multi-media patient summary 12 (FIGS. 1 and 2). A login/authentication function may be required (similar to block 78), and if so, once authenticated, the same or different operator or clinician (i.e., a supplier or assembler of information), such as a specialist or technician, may access the desired files of patient information (block 80), translate the patient data into an appropriate format (block 82), and insert the information/data into the patient summary 12 (block 84).

As previously discussed, the patient summary 12 may be stored (block 86), for example, on a server or network for further access by a user or client 46 (FIG. 1), such as a patient or referring physician (blocks 88 and 90). The summary 12 may be manually or automatically pushed (block 88) to the user or client, for example, via an email attachment. Conversely, the summary 12 may be pulled (block 90) by a user or client 46, for example, by clicking on a link in a notification email sent by a specialist, operator, or automatically sent by a server. Of course, the client 46, if granted access, may log in locally or remotely to a medical facility data network to retrieve a multi-media patient summary 12 for a patient 14.

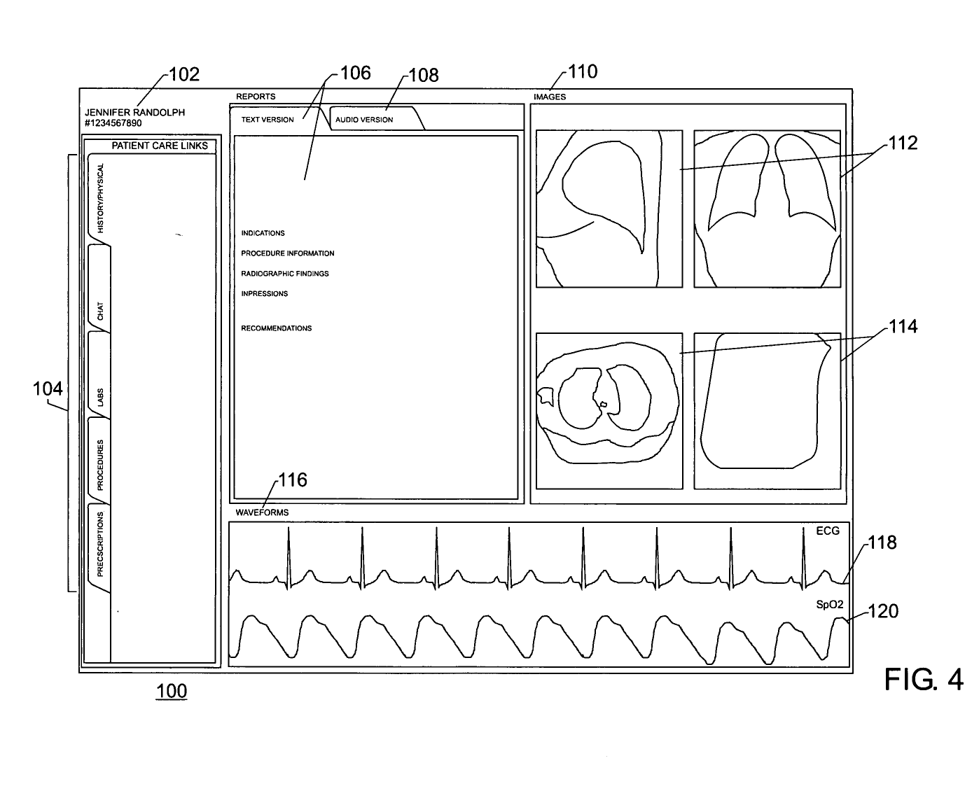

Referring to FIG. 4, a perspective view of a multi-media patient summary 100, is depicted. This illustrative embodiment demonstrates a user display interface for an encrypted file format of the summary 100. In the present infrastructure context, patient data, such as compressed images (i.e., “jpg's”), compressed audio/sound (i.e., “avi”), text, and waveforms, are typically small enough to be distributed via the internet. Thus, as mentioned above, the summary 100 may be emailed to a user, client, referring physician, patient, and so forth. Moreover, the summary 100 may provide hyperlinks to applications, such as WebPACS, which displays higher resolution media or other more detailed information. For example, it may not be intended that the multi-media patient summary 100 provide the same level and detail of information as a diagnostic quality workstation. Instead, the summary 100 may be geared toward clinicians, such as referring physicians, who may be better served by easily accessible summarized findings.

As might be expected, the patient summary 100 should typically identify patient 14 (FIG. 1), such as with a patient ID 102. Additionally, tabs 104 which may be aligned and selectable may provide related pages that organize the patient information. Such pages may include categorized information, such as medical history, physical results, charts, lab work, procedures, prescriptions, and so forth. The tabs 104 may also represent, for example, links to information systems outside of the multi-media patient summary 100.

Patient information may be condensed and summarized in a textual report/summary 106 section including, for example, a few paragraphs or sentences (or no text), hypertext links to access more data, or some combination. In particular, the textual report/summary 106 may include headings which identify the patient and hospital, as well as, distilled information, such as patient indications, procedure information, radiographic findings, recommendations, and so forth. In this embodiment, the client may listen to an audio version of the report/summary 108 section, which may be selected, for example, by clicking a descriptive tab indicating an audio version of the report.

As previously discussed, examples of images 110 that may be encapsulated into the multi-media patient summary 100 are X-rays 112 and CT slices 114. Waveforms 116, such as an ECG waveform 118 or SpO2 waveforms 120, may also be encapsulated. Images 110 and waveforms 116 may be pushed, for example, by a specialist or operator to the multimedia patient summary 100.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A multi-media patient summary comprising:
a digital file encapsulating patient information of one or more formats and generated by:
accessing patient information at a compilation workstation from one or more systems;
entering the patient information into the digital file;
storing the digital file onto a machine readable medium; and
loading the digital file at one or more remote client workstations.

2. The multi-media patient summary of claim 1, wherein the one or more formats of the patient information is at least one of text, an image, a waveform, audio, and a hypertext link.

3. The multi-media patient summary of claim 1, wherein the patient information is accessed from at least one of an image handling system, an information system, and a diagnostic modality interface.

4. A method for providing a multi-media patient summary, comprising:
accessing patient information of one or more formats from one or more systems to a compilation workstation;
assembling the patient information into a digital file;
storing the digital file onto a machine readable medium; and
accessing the digital file at one or more client workstations.

5. The method of claim 4, further comprising electronically transmitting the digital file to a client.

6. The method of claim 4, wherein a format of the digital file is an encapsulated file having patient information in a format of at least one of text, images, sound files, waveforms, and hypertext links.

7. The method of claim 4, wherein a system that supplies patient information is at least one of a picture archival communication system, a radiology department information system, a hospital information system, and a cardiovascular information system.

8. The method of claim 4, wherein a system that supplies patient information is a magnetic resonance imaging system.

9. The method of claim 4, wherein a system that supplies patient information is a computed tomography imaging system.

10. The method of claim 4, wherein the client workstation is a general purpose computer.

11. The method of claim 4, wherein the client workstation is a personal digital assistant electronic handheld device.

12. The method of claim 4, wherein the digital file is configured to be accessed by a physician at the one or more client workstations.

13. The method of claim 4, wherein the digital file is configured to be accessed by a patient at the one or more client workstations.

14. A method for generating a multi-media patient summary, comprising:
configuring an electronic template at a compilation workstation to receive patient information of one or more formats from one or more systems;
receiving and encapsulating the patient information in the electronic template and compiling a multi-media patient summary;
storing the multi-media patient summary on a machine readable medium; and
displaying the multi-media patient summary at one or more remote client workstations.

15. The method of claim 14, further comprising notifying a client of the status of the multi-media patient summary.

16. The method of claim 14, further comprising accessing and replaying one or more patient information sound files compiled in the multi-media patient summary.

17. The method of claim 14, further comprising selecting one or more user-selectable regions of the multi-media patient summary to display additional patient information.

18. The method of claim 14, further comprising viewing one or more patient information images compiled in the multi-media patient summary.

19. The method of claim 14, further comprising viewing one or more patient information waveforms compiled in the multi-media patient summary.

20. The method of claim 14, wherein patient information is received from a picture archival communication system.

19. The method of claim 14, wherein patient information is received from a hospital information system.

20. The method of claim 14, wherein patient information is received from a radiology department information system.

21. The method of claim 16, wherein patient information is received from a MRI system.

22. The method of claim 16, wherein patient information is received from a CT system.

23. The method of claim 16, wherein patient information is received from electrocardiography system as a waveform.

24. A system for creating a multi-media patient summary, comprising:
at least one compilation workstation configured to receive patient information of one or more formats from one or more sources;
the at least one compilation workstation configured to assemble and encapsulate the patient information into a digital file;
the at least one compilation workstation configured to store the digital file on at least one machine readable medium; and
at least one client workstation capable of accessing the digital file.

25. The system of claim 24, wherein the format of the patient information is at least one of text, an image, a waveform, audio, and a hypertext link.

26. The system of claim 24, wherein the patient information is supplied from at least one of an image handling system, an information system, and a diagnostic modality interface.

27. A system for providing a multi-media patient summary, comprising:
means for accessing patient information of one or more formats from one or more systems;
means for assembling the patient information into an electronic file capable of encapsulating patient information having different formats;
means for storing the electronic file; and
means for accessing the electronic file.

28. A computer program, provided on one or more tangible media, for generating a multi-media patient summary, comprising:
a routine for receiving patient information of one or more formats from one or more systems at to one or more compilation workstations;
a routine for assembling and encapsulating the patient information into a digital file;
a routine for storing the digital file onto one or more machine readable media; and
a routine for loading the digital file at one or more client workstations.

29. The computer program of claim 28, wherein the patient information is provided from at least one of an image handling system, an information system, and a diagnostic modality interface.

30. The computer program of claim 28, wherein the format of the patient information is at least one of text, an image, a waveform, audio, and a hypertext link.

31. The computer program of claim 28, wherein the one or more client workstations are at least one of a general purpose computer and a personal digital assistant electronic handheld device.
